(19) United States
(12) Patent Application Publication
(10) Pub. No.: US 2014/0247520 A1
(43) Pub. Date: Sep. 4, 2014

(54) MAGNETIC STORAGE MEDIUM AND MAGNETIC RECORDING APPARATUS

(71) Applicant: Kabushiki Kaisha Toshiba, Minato-ku (JP)

(72) Inventors: Tao YANG, Bloomington, MN (US); Hirofumi Suto, Tokyo (JP); Juwany Kudo, Kamakura-shi (JP); Tazumi Nagasawa, Yokohama-shi (JP); Rie Sato, Yokohama-shi (JP); Koichi Mizushima, Kamakura-shi (JP)

(73) Assignee: Kabushiki Kaisha Toshiba, Minato-ku (JP)

(21) Appl. No.: 14/104,221

(22) Filed: Dec. 12, 2013

(30) Foreign Application Priority Data
Mar. 4, 2013 (JP) 2013-042164

(51) Int. Cl. G11B 5/66

(52) U.S. Cl. CPC G11B 5/66
USPC 360/110; 428/800

(57) ABSTRACT

According to one embodiment, a magnetic storage medium includes a plurality of recording layers and a first non-magnetic layer. The plurality of recording layers each includes at least one first magnetic layer and at least one second magnetic layer. The first magnetic layer is made of a first magnetic material which has a first effective perpendicular magnetic anisotropy. Data is stored in first magnetic layer in accordance with a direction of magnetization. The second magnetic layer is made of a second magnetic material having a second effective perpendicular magnetic anisotropy smaller than the first effective perpendicular magnetic anisotropy. First magnetization of the first magnetic layer and second magnetization of the second magnetic layer are in magnetic coupling.

### CROSS-REFERENCE TO RELATED APPLICATIONS

This application is based upon and claims the benefit of priority from Japanese Patent Application No. 2013-042164, filed Mar. 4, 2013, the entire contents of which are incorporated herein by reference.

### FIELD

Embodiment described herein relates to a magnetic storage medium and magnetic recording apparatus.

### BACKGROUND

As a mainstream storage technique, magnetic storage has been increasing its storage density remarkably. For continuing this growth in the storage density, three-dimensional magnetic recording has been proposed. In comparison with a conventional single-layer storage medium, a three-dimensional magnetic storage medium has multiple recording layers allowing the storage density per unit area to increase in accordance with the number of layers. To read out data from the three-dimensional magnetic storage medium, ferromagnetic resonance frequency is utilized to select a layer and to determine a magnetization direction thereof. Such a reading method requires a read head to generate a matching high-frequency magnetic field to excite ferromagnetic resonance in the recording layer of the three-dimensional magnetic storage medium.

### BRIEF DESCRIPTION OF THE DRAWINGS

FIG. 1 illustrates an example of a magnetic storage medium.

FIG. 2A illustrates a case where the magnetization is in ferromagnetic coupling.

FIG. 2B illustrates a case where the magnetization is in antiferromagnetic coupling.

FIG. 3 illustrates a different example of the magnetic storage medium.

FIG. 4 illustrates an example of utilization of the magnetic storage medium.

FIG. 5A illustrates a method for reading the magnetic storage medium in which ferromagnetic resonance occurs.

FIG. 5B illustrates a method for reading the magnetic storage medium in which ferromagnetic resonance does not occur.

FIG. 6 illustrates a dependence of ferromagnetic resonance absorption on frequency.

FIG. 7A illustrates a first transformation example of the recording layer, which illustrates a case where the magnetization is in ferromagnetic coupling.

FIG. 7B illustrates a first transformation example of the recording layer, which illustrates a case where the magnetization is in antiferromagnetic coupling.

FIG. 8A illustrates a second transformation example of the recording layer, which illustrates a case where the magnetization is in ferromagnetic coupling.

FIG. 8B illustrates a second transformation example of the recording layer, which illustrates a case where the magnetization is in antiferromagnetic coupling.

FIG. 9A illustrates a third transformation example of the recording layer, which illustrates a case where the magnetization is in ferromagnetic coupling.

FIG. 9B illustrates a third transformation example of the recording layer, which illustrates a case where the magnetization is in antiferromagnetic coupling.

FIG. 10 illustrates an example of a magnetic recording apparatus using the magnetic storage medium.

FIG. 11 illustrates an example of fabricating a magnetic storage medium using the recording layer.

FIG. 12 illustrates a measurement result of ferromagnetic resonance absorption of the magnetic storage medium.

FIG. 13 illustrates an example of fabricating a magnetic storage medium using a conventional single-layer recording layer.

FIG. 14 illustrates a measurement result of ferromagnetic resonance absorption of a conventional single-layer magnetic storage medium.

### DETAILED DESCRIPTION

To conserve data stored in a three-dimensional magnetic storage medium with high-density, a material having large magnetic anisotropy must be used in a recording layer. However, when the magnetic anisotropy becomes larger, the ferromagnetic resonance frequency becomes higher, and thus, a read head needs to generate a high-frequency magnetic field of several tens of gigahertz. A spin torque oscillator which has been used in this technical field can stably oscillate at a frequency of only a few gigahertz. Thus, there is a technical difficulty in fabricating a head element that can generate a high-frequency magnetic field of several tens of gigahertz.

Furthermore, a ferromagnetic resonance absorption peak that represents the relationship of absorption amplitude and frequency of the ferromagnetic resonance absorption on a spectrum has a wider linewidth when the magnetic anisotropy becomes larger. In the three-dimensional magnetic recording, recording layers are distinguished from each other by using differences in resonance frequency, and thus, a ferromagnetic resonance peak with narrow linewidth is desirable from the viewpoint of increasing the number of recording layers included in a three-dimensional storage medium.

The thermal stability of magnetic crystal grains is represented by KᵤV/k_{B}T, where Kᵤ, V, k_{B}, and T are the magnetic anisotropy energy constant, volume, Boltzmann constant, and temperature, respectively. If the thermal stability is insufficient, a magnetization direction may be reversed even at room temperature due to thermal fluctuations, and stored data may be lost. Thus, for keeping high-density data stable, a condition KᵤV/k_{B}T>60 must be satisfied, which overcomes superparamagnetic phenomenon in nano-sized magnetic crystal grains of a magnetic storage medium.

Furthermore, the ferromagnetic resonance frequency is given by the Kittle formula (1),

$$f = \frac{γ}{2 π} ( {h}_{a}^{eff} + {h}_{e} ) , \qquad ( 1 )$$

where γ is the gyromagnetic ratio, hₐ^{eff} is the effective anisotropic field, and hₑ is the external magnetic field. As can be understood from formula (1), when magnetic anisotropy becomes larger, the ferromagnetic resonance frequency becomes higher. For example, when the effective magnetic anisotropy field of the magnetic storage medium is 1T, the ferromagnetic resonance frequency is approximately 28 GHz. However, a desirable ferromagnetic resonance frequency is less than 10 GHz, considering use of a spin-torque oscillator as a high-frequency magnetic field source.

The relationship between the linewidth Δf, damping coefficient α, and center frequency f can be represented by Δf∝αf. As mentioned above, when the magnetic anisotropy becomes larger, the ferromagnetic resonance frequency becomes higher, In addition, the damping tends to become larger with the increase of the magnetic anisotropy, and from these two contributions, the linewidth of the ferromagnetic resonance absorption peak becomes wider. In a three-dimensional magnetic storage medium, the narrow absorption peak means that one storage layer occupies narrow frequency bands, enabling more recording layers to share the total frequency band covered by the spin-torque oscillator. Thus, to improve the recording density, smaller damping coefficient is desired.

In general, according to one embodiment, a magnetic storage medium includes a plurality of recording layers and a first non-magnetic layer. The plurality of recording layers each includes at least one first magnetic layer and at least one second magnetic layer, the first magnetic layer is made of a first magnetic material which has a first effective perpendicular magnetic anisotropy and data is stored in first magnetic layer in accordance with a direction of magnetization. The second magnetic layer is made of a second magnetic material having a second effective perpendicular magnetic anisotropy that is smaller than the first effective perpendicular magnetic anisotropy. First magnetization that is magnetization of the first magnetic layer and second magnetization that is magnetization of the second magnetic layer are magnetically coupled. The first non-magnetic layer is made of a non-magnetic material and provided between the recording layers.

In the following, the magnetic storage medium and magnetic recording apparatus of the present embodiment will be described in detail with reference to the drawings. In the embodiment described below, units specified by the same reference number carry out the same operation, and may only be explained once.

The magnetic storage medium of the present embodiment is described with reference to FIG. 1. FIG. 1 is a cross-sectional view illustrating an example of the magnetic storage medium.

A magnetic storage medium 100 includes a plurality of recording layers 101 and isolation layers 102.

The recording layer 101 is made of a magnetic material, and is capable of recording binary data item represented by the magnetization direction.

The isolation layer 102 is provided between two of the recording layers 101, and magnetically separates the two recording layers 101. The isolation layer 102 may be made of a material which does not cause magnetic exchange coupling between the recording layers 101, such as Ta and Ti.

FIG. 1 illustrates an example of the magnetic storage medium 100 having two recording layers 101 in which an isolation layer 102 is inserted therebetween. The magnetic medium 100 may have further set of alternately stacked recording layers and intermediate layers as shown in FIG. 1.

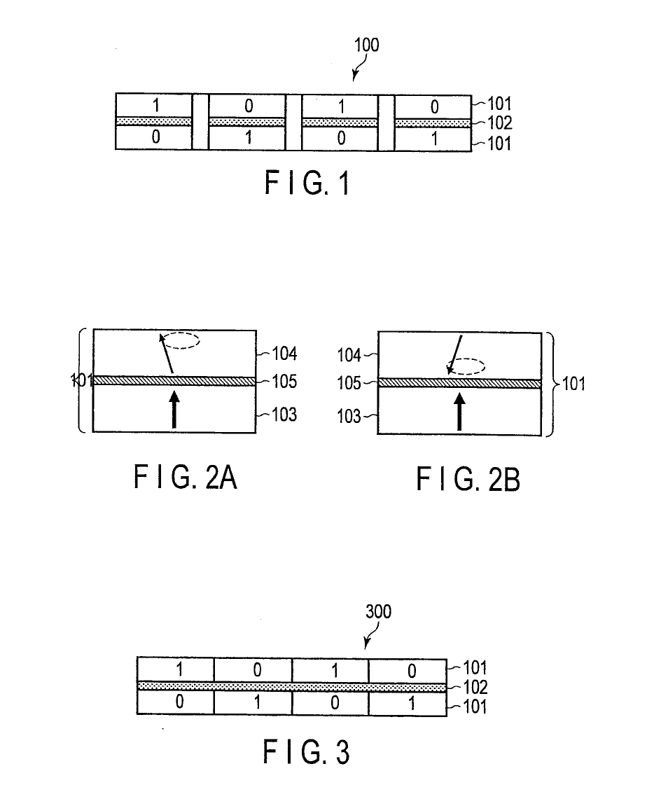

Now, the recording layer 101 is described with reference to FIGS. 2A and 2B.

FIGS. 2A and 2B is a cross-sectional view illustrating an example of the recording layer, and FIG. 2A illustrates a case where both magnetization directions are coupled in parallel configuration (hereinafter referred to as ferromagnetic coupling) and FIG. 2B illustrates a case where the magnetization directions are coupled in antiparallel configuration (hereinafter referred to as antiferromagnetic coupling).

The recording layer 101 includes a first magnetic layer 103, a second magnetic layer 104, and a non-magnetic intermediate layer 105.

The first magnetic layer 103 is made of a material having large magnetic anisotropy; namely, a hard magnetic material such as CoCr alloy, FePt alloy, Co/Pt(Pd) multilayer film, RE-TM alloy, and CoPt alloy, and guarantees the stability of data. The first magnetic layer 103 preferably has an effective perpendicular magnetic anisotropy energy density of a few Merg/cm³ or more. In addition to the above-mentioned materials, another material that can achieve KᵤV/k_{B}T higher than 60 can also be used for the first magnetic layer 103.

The second magnetic layer 104 is made of a magnetic material whose effective perpendicular magnetic anisotropy is smaller than that of the first magnetic layer 103; namely, Co alloy, CoCr alloy or Co/Pt(Pd) multilayer. The ferromagnetic resonance frequency of the second magnetic layer 104 is, desirably, approximately 10 GHz or less.

Here, by changing compositions of the materials used in the first magnetic layer 103 and second magnetic layer 104, the magnetic anisotropy can be adjusted, and thus, the same material system can be used for the both first magnetic layer 103 and second magnetic layer 104.

The non-magnetic intermediate layer 105 is provided between the first magnetic layer 103 and the second magnetic layer 104, and is formed of a non-magnetic material such as Ru, Cr and Mo. The non-magnetic intermediate layer 105 causes magnetic exchange coupling between the first magnetic layer 103 and the second magnetic layer 104. The materials of the non-magnetic intermediate layer 105 are not limited thereto, and may be other materials which bring ferromagnetic coupling or antiferromagnetic coupling between the first magnetic layer 103 and the second magnetic layer 104.

By the magnetic exchange coupling and magnetostatic effect, the magnetization of the first magnetic layer 103 and the magnetization of the second magnetic layer 104 are coupled. Thereby, the magnetization of the first magnetic layer 103 and the magnetization of the second magnetic layer 104 are stable either in ferromagnetic or antiferromagnetic configuration.

In the case of the stable antiferromagnetic coupling as shown in FIG. 2B, stray fields from the first magnetic layer 103 and the second magnetic layer 104 cancel each other, which suppresses inter-bit interference caused by the stray fields and influence from the medium on a head element.

To maintain ferromagnetic or antiferromagnetic coupling, the coercivity of the second magnetic layer 104 is designed to be smaller than a coupling field which represents the strength of the ferromagnetic or antiferromaynetic coupling between the first magnetic layer 103 and the second magnetic layer 104.

FIG. 1 illustrates an example of the magnetic storage medium 100 fabricated by a bit-patterned medium (BPM) technique in which recording bits are separated; however, the magnetic storage medium 100 may be a continuous medium.

FIG. 3 illustrates another example of the magnetic storage medium of the present embodiment.

As a magnetic storage medium 300 shown in FIG. 3, a continuous medium in which adjacent recording bits do not separate from each other may be used as the recording layer 101.

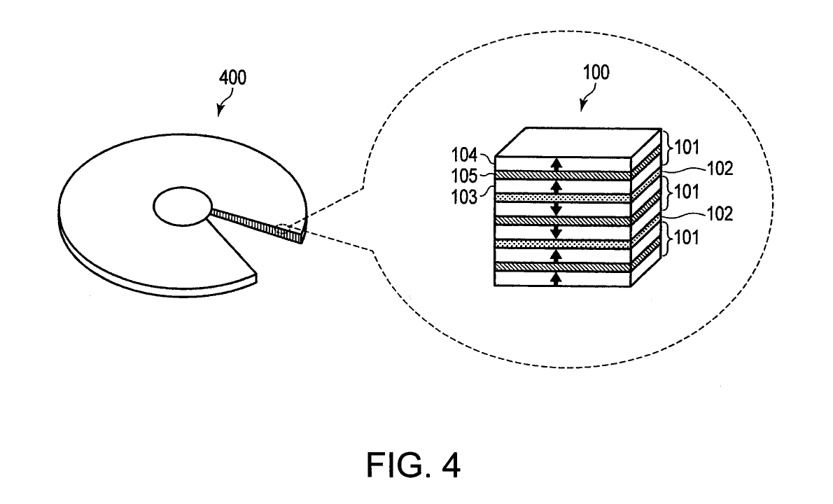

FIG. 4 illustrates an example of utilization of the magnetic storage medium 100.

As shown in FIG. 4, the magnetic medium 100 of the present embodiment is used in a circular multilayer disk 400 similar to the one used in hard disk drives (HDDs). In this medium, characteristics affecting the ferromagnetic resonance frequency, such as magnetic anisotropy and saturation magnetization are differentiated for each recording layer 101 by changing the composition of the first magnetic layer 103 and second magnetic layer 104. By such a process, each layer has different ferromagnetic resonance frequencies. Otherwise, the resonance frequency of each layer may also be differentiated by changing the composition and film thickness of the non-magnetic intermediate layer 105 and adjusting a coupling field. The ferromagnetic resonance frequency of each recording layer 101 comprising the circular multilayer disk 400 may be set in such a way that they increase from the upper layer to the lower layer, or from the lower layer to the upper layer. The choice is optional.

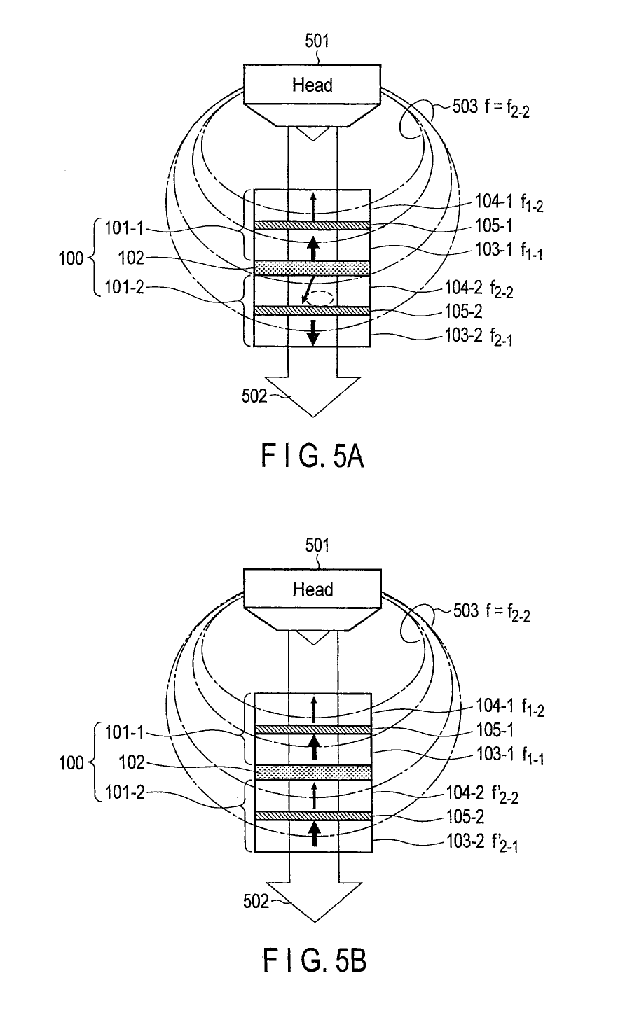

A method to read out data recorded in the magnetic storage medium 100 is now described with reference to FIGS. 5A and 5B.

In FIGS. 5A and 5B, a case is given where the magnetic storage medium 100 has two recording layers 101, magnetization of first magnetic layer 103 and magnetization of second magnetic layer 104 are in ferromagnetic coupling, and data is read out using ferromagnetic resonance induced by a field generated by the read head 501.

To reproduce data, as shown in FIG. 5A, an external magnetic field 502 is applied from the read head 501 to all recording layers; namely, the recording layer 101-1 and recording layer 101-2. To generate the external magnetic field 502, a method for magnetizing a magnetic pole in a head by electric current magnetic field may be used. The applied external magnetic field 502 is set not to exceed a switching field of the second magnetic layer 104 to avoid the breaking of ferromagnetic or antiferromagnetic coupling between the first magnetic layer 103 and second magnetic layer 104. The reversal magnetic field is determined by coercivity and coupling magnetic field of the second magnetic layer 104.

Here, ferromagnetic resonance frequency of the first magnetic layer 103-1 and ferromagnetic resonance frequency f₂₋₁ of the first magnetic layer 103-2 are approximately several tens of gigahertz due to their large magnetic anisotropy whereas ferromagnetic resonance frequency f₁₋₂ of the second magnetic layer 104-1 and the ferromagnetic resonance frequency f₂₋₂ of the second magnetic layer 104-2 are approximately 10 GHz or less due to their small magnetic anisotropy.

To read the data recorded in the recording layer 101-2, the external magnetic field 502 and the high-frequency magnetic field 503 with the frequency f₂₋₂ is generated from the read head 501. Among the magnetization of the magnetic layers shown in FIG. 5A, only that of the second magnetic layer 104-2 having the ferromagnetic resonance frequency f₂₋₂ is excited because the FMR frequency thereof matches the frequency of the high-frequency magnetic field 503 generated from the read head 501. As a result of ferromagnetic resonance excitation in the second magnetic layer 104-2, the energy of the high-frequency magnetic field 503 is absorbed.

On the other hand, FIG. 5B illustrates a case where the magnetization direction of the second magnetic layer 104-2 is opposite to that of the external magnetic field 502. In this case, the ferromagnetic resonance frequency of the second magnetic layer 104-2 changes to f′₂₋₂ based on the formula (1). Therefore, when the high-frequency magnetic field 503 with frequency f₂₋₂ is generated from the read head 501, the ferromagnetic resonance excitation does not occur in the second magnetic layer 104-2 due to the discrepancy between the frequency f₂₋₂ of the high-frequency magnetic field 503 and the ferromagnetic resonance frequency f′₂₋₂ of the second magnetic layer 104-2, and no energy absorption occurs.

Whether or not energy is absorbed is detected by using a conventional technique to analyze a spin-torque oscillator such as reading output signal and measuring its power and frequency. The detailed explanation is omitted here.

Whether magnetization between the first magnetic layer 103 and the second magnetic layer 104 is in ferromagnetic or antiferromagnetic coupling is determined by the film structure of the non-magnetic intermediate layer 105 therebetween, the magnetization direction of the first magnetic layer 103 can be deduced from the magnetization direction of the second magnetic layer 104, and the stored data can be reproduced. In the example of FIGS. 5A and 5B, the magnetization between the first magnetic layer 103 and the second magnetic layer 104 is ferromagnetic coupling, and thus, the recorded data represented by the direction of the first magnetic layer 103 is determined to be the same as that of the second magnetic layer 104.

As explained above, a magnetization direction in a magnetic layer of a recording layer to be read out can be detected from presence/absence of energy absorption of a high-frequency magnetic field. By reading the magnetization direction of the second magnetic layer 104 with a low ferromagnetic resonance frequency, instead of the first magnetic layer 103 with a high ferromagnetic resonance frequency, the frequency of the high-frequency magnetic field 503 can be lowered.

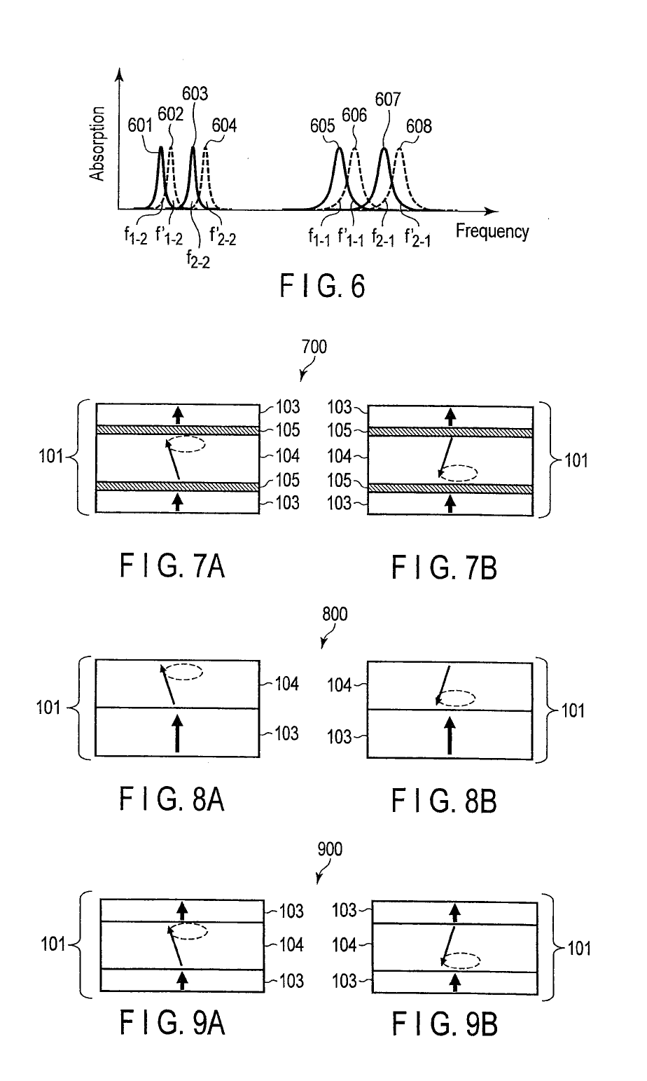

Now, a dependence of ferromagnetic resonance absorption on frequency is described with reference to FIG. 6. FIG. 6 illustrates a dependence of ferromagnetic resonance absorption on frequency in each magnetic layer and ferromagnetic resonance absorption peak. The lateral axis represents ferromagnetic resonance frequency and vertical axis represents the amplitude of ferromagnetic resonance absorption.

A peak 601 is a resonance absorption peak in a case where a magnetization direction of a second magnetic layer 104-1 is antiparallel to the external magnetic field, and a peak 602 is a resonance absorption peak in a case where a magnetization direction of the second magnetic layer 104-1 is parallel to the external magnetic field. Similarly, a peak 603 is a resonance absorption peak in a case where a magnetization direction of a second magnetic layer 104-2 is antiparallel to the external magnetic field, and a peak 604 is a resonance absorption peak in a case where a magnetization direction of the second magnetic layer 104-2 is parallel to the external magnetic field. A peak 605 is a resonance absorption peak in a case where a magnetization direction of a first magnetic layer 103-1 is antiparallel to the external magnetic field, and a peak 606 is a resonance absorption peak in a case where a magnetization direction of the first magnetic layer 103-1 is parallel to the external magnetic field. A peak 607 is a resonance absorption peak in a case where a magnetization direction of a first magnetic layer 103-2 is antiparallel to the external magnetic field, and a peak 608 is a resonance absorption peak in a case where a magnetization direction of the first magnetic layer 103-2 is parallel to the external magnetic field.

As shown in FIG. 6, the ferromagnetic resonance absorption peaks of the first magnetic layer 103-1 and 103-2 have very high center frequencies and broad linewidth due to their large magnetic anisotropy. On the other hand, by reading the magnetization direction of the second magnetic layer 104 whose ferromagnetic resonance frequency is low, the linewidth is narrowed and recorded data can easily be read.

In a case where the magnetization of the first magnetic layer 103 and the magnetization of the second magnetic layer 104 are in antiferromagnetic coupling, the data can be read out as a opposite direction of the magnetization direction of the second magnetic layer 104 by using the same method as the readout method shown in FIG. 5.

In the above-mentioned example, a non-magnetic intermediate layer 105 is inserted between the first magnetic layer 103 and the second magnetic layer 104; however, the other structure may be adopted.

A first transformation example of the recording layer 101 is described with reference to FIGS. 7A and 7B.

FIG. 7A illustrates a case where magnetization is in ferromagnetic coupling and FIG. 7B illustrates a case where magnetization is in antiferromagnetic coupling.

For example, as shown in FIGS. 7A and 7B, a recording layer 104 may be structured by laminating a first magnetic layer 103, a non-magnetic intermediate layer 105, a second magnetic layer 104, a non-magnetic intermediate layer 105, and a first magnetic layer 103 in this order. Compared with the structure shown in FIG. 2B that has one first magnetic layer 103 and one second magnetic layer 104, this structure is advantageous in reducing the net stray field. Thus, a stray field to the other recording layers can be reduced.

In the above-mentioned example, magnetic coupling between the first magnetic layer 103 and the second magnetic layer 104 is achieved via the non-magnetic intermediate layer 105; however, a non-magnetic intermediate layer 105 is optional.

Now, a second transformation example of a recording layer 101 is described with reference to FIGS. 8A and 8B.

FIG. 8A illustrates a case where magnetization is in ferromagnetic coupling and FIG. 8B illustrates a case where magnetization is in antiferromagnetic coupling. As shown in FIGS. 8A and 8B, the first magnetic layer 103 and the second magnetic layer 104 may be stacked directly.

Now, a third transformation example of a recording layer 101 is described with reference to FIGS. 9A and 9B.

FIG. 9A illustrates a case where magnetization is in ferromagnetic coupling and FIG. 9B illustrates a case where magnetization is in antiferromagnetic coupling.

FIG. 9 illustrates a transformation example of FIG. 7 the first magnetic layer 103 and the second magnetic layer 104 are stacked directly without providing a non-magnetic intermediate layer 105 therebetween.

By such direct exchange coupling between the first magnetic layer 103 and the second magnetic layer 104, ferromagnetic or antiferromagnetic coupling of magnetization is achievable. Compared to a case where a non-magnetic intermediate layer 105 is provided in the layer, the structures in FIGS. 8A, 8B, 9A, and 9B are advantageous from the viewpoint of reducing a film thickness. When antiferromagnetic coupling is desired as shown in FIG. 8B and FIG. 9B, an RE rich alloy such as RE(Tb, Gb, Dy)-TM(Co, Fe, Ni) alloy may be used as a first magnetic layer 103.

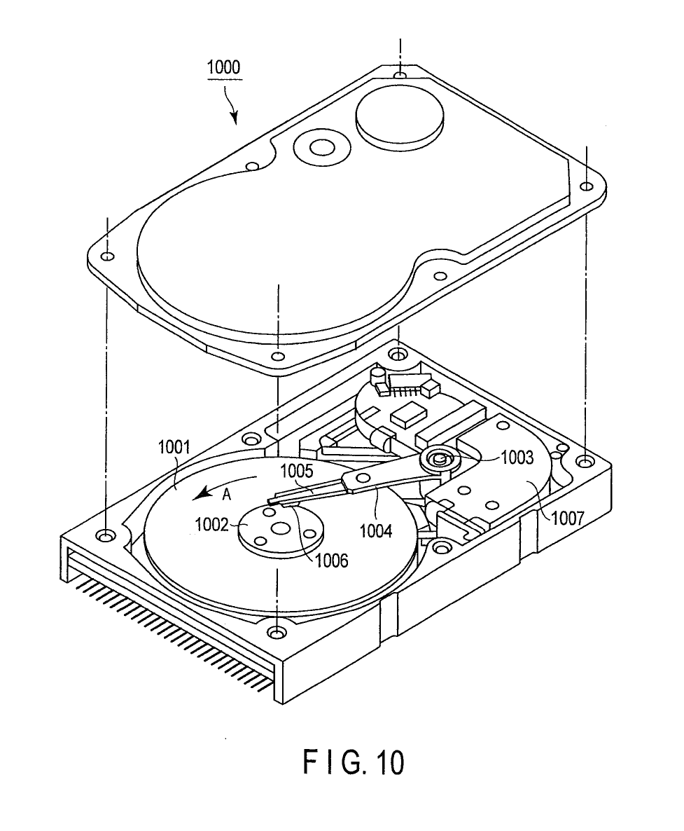

As a magnetic recording apparatus of the present embodiment, a hard disk drive (HDD) mounting a read head and magnetic storage medium shown in FIG. 5 may be used. Here, such a HDD is described with reference to FIG. 10. The magnetic storage medium shown in FIG. 4 may be used in this HDD.

The magnetic recording apparatus 1000 shown in FIG. 10 comprises a magnetic disk (magnetic storage medium) 1001. The magnetic disk 1001 is attached to a spindle 1002 and is rotated in a direction of an arrow A by means of the spindle motor.

A pivot 1003 provided near to the magnetic disk 1001 holds an actuator arm 1004. To a distal end of the actuator arm 1004, a suspension 1005 is attached. At a lower surface of the suspension 1005, the read head 1006 is supported. A voice coil motor 1007 is formed at a proximal end portion of the actuator arm 1004.

By rotating the magnetic disk 1001, and rotating the actuator arm 704 by the voice coil motor 1007 to load the read head 1006 on the magnetic disk 1001, data recorded on the magnetic disk 1001 can be reproduced.

### Example

As an embodiment, an example of fabricating a magnetic storage medium is describe hereinafter and a layered structure of a magnetic storage medium using a recording layer of the present embodiment is compared to a layered structure of a magnetic storage medium of a conventional single-layer recording layer.

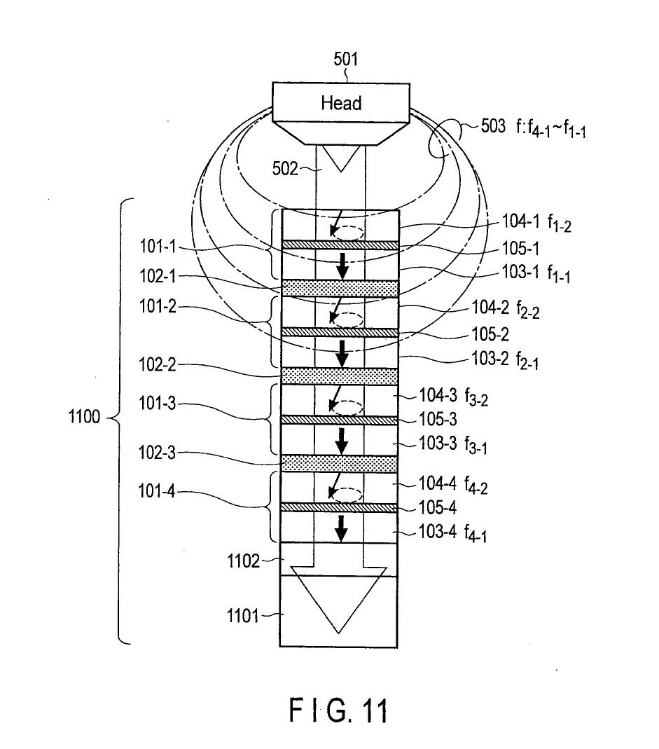

An example of fabricating a magnetic storage medium using a recording layer of the present embodiment is described with reference to FIG. 11.

The layered structure of the magnetic storage medium 1100 is layered, from the bottom, a silicon substrate 1101, a seed layer 1102, a recording layer 101-4, an isolation layer 102-3, a recording layer 101-3, an isolation layer 102-2, a recording layer 101-2, an isolation layer 102-1, and a recording layer 101-1 in this order. The magnetic storage medium 1100 thus comprises four recording layers 101.

The magnetic storage medium 1100 of the present embodiment is deposited on the silicon substrate 1101 by the sputtering process.

The recording layer 101-1 includes a first magnetic layer 103-1, a second magnetic layer 104-1, and a non-magnetic intermediate layer 105-1. Similarly, the recording layer 101-2 includes a first magnetic layer 103-2, a second a magnetic layer 104-2, a non-magnetic intermediate layer 105-2, the recording layer 101-3 includes a first magnetic layer 103-3, a second magnetic layer 104-3, and a non-magnetic intermediate layer 105-2, the recording layer 101-4 includes a first magnetic layer 103-4, a second magnetic layer 104-4, and a non-magnetic intermediate layer 105-4.

The first magnetic layer 103 included in each recording layer 101 is generated as a Pt/Co multilayer structure. Specifically, the first magnetic layer 103-1 is a (Pt 6 Å/Co 3 Å)₁₀ multilayer structure, the first magnetic layer 103-2 is a (Pt 6 Å/Co 3.5 Å)₁₀ multiplayer structure, the first magnetic layer 103-3 is a (Pt 6 Å/Co 4.1 Å)₁₀ multilayer structure, and the first magnetic layer 103-4 is a (Pt 6 Å/Co 7.1 Å)₁₀ multilayer structure.

The second magnetic layer 104 included in each recording layer 101 is generated as a Pt/Co multilayer structure. Specifically, the second magnetic layer 104-1 is a (Pt 6 Å/Co 14.2 Å)₁₀ multilayer structure, the second magnetic layer 104-2 is a (Pt 6 Å/Co 15.0 Å)₁₀ multiplayer structure, the second magnetic layer 103-3 is a (Pt 6 Å/Co 15.7 Å)₁₀ multilayer structure, and the second magnetic layer 104-4 is a (Pt 6 Å/Co 16.3 Å)₁₀ multilayer structure.

The non-magnetic intermediate layer 105 included in each recording layer 101 is a Ru layer having a thickness of 0.85 nm.

Each of the isolation layers 102-1 and 102-3 and seed layer 1102 is a Ta layer having a thickness of 5 nm.

The Pt/Co multilayer structure involves perpendicular magnetic anisotropy caused by an interface, and the size of the perpendicular magnetic anisotropy is in inverse proportion to a thickness of a Co layer. As shown in FIG. 11, the Pt/Co multilayer involves large perpendicular anisotropy and thermal stability as a medium. Since the thickness of Co is different in the first magnetic layers 103-1 to 103-4, the ferromagnetic resonance frequency is different as well. Thus, the ferromagnetic resonance of the desired layer can be selectively excited utilizing the frequency and data can be reproduced from a desired recording layer.

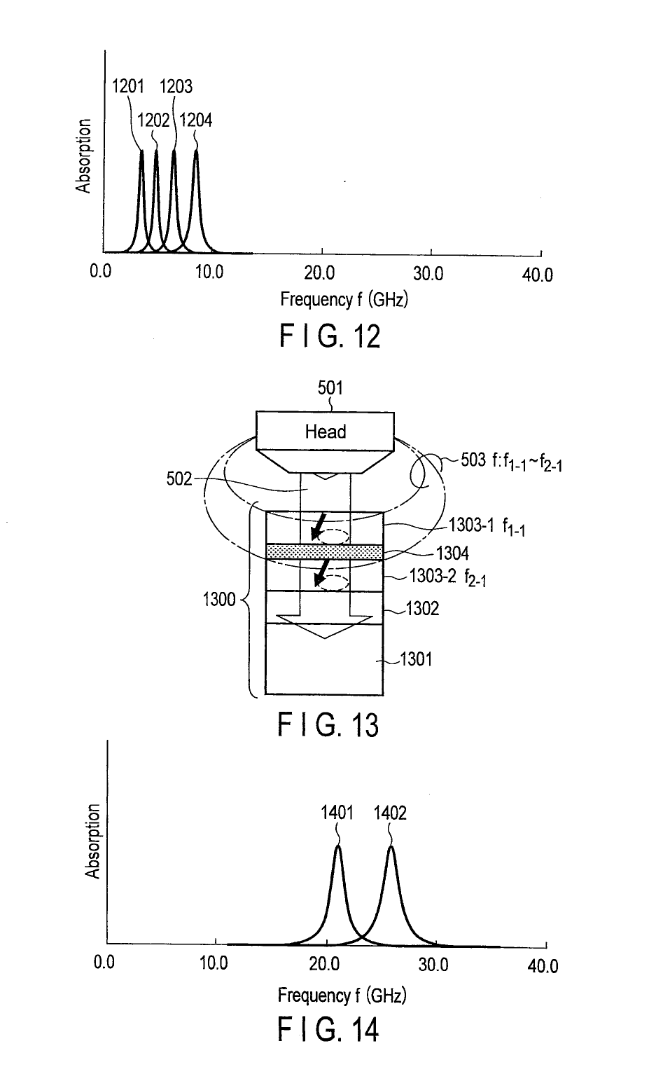

The measurement results of the ferromagnetic resonance absorption of the magnetic storage medium 1100 shown in FIG. 11 are illustrated in FIG. 12.

The lateral axis represents ferromagnetic resonance frequency and the vertical axis represents ferromagnetic resonance absorption.

Effective magnetic anisotropy of the first magnetic layer 103 is approximately 10 Merg/cm³, and effective magnetic anisotropy of the second magnetic layer 104 is 1 Merg/cm³ or less. Since the effective perpendicular magnetic anisotropy is large in the first magnetic layer 103, the ferromagnetic resonance frequency is not shown in FIG. 12. On the other hand, a ferromagnetic resonance absorption peak of the second magnetic layer 104-1 is a peak 1201, a ferromagnetic resonance absorption peak of the second magnetic layer 104-2 is a peak 1202, a ferromagnetic resonance absorption peak of the second magnetic layer 104-3 is a peak 1203, and a ferromagnetic resonance absorption peak of the second magnetic layer 104-4 is a peak 1204. As shown in FIG. 12, the entire four layers are 10 GHz or less, and data can be reproduced by detecting ferromagnetic resonance absorption.

Furthermore, each of the second magnetic layers 104 has a damping coefficient of approximately 0.03, which yields the linewidth of a peak of approximately 500 MHz, whereas the peak interval is approximately 1 GHz. Thus, adjacent peaks can be distinguished from each other.

Here, an example of fabricating a magnetic storage medium 1300 having conventional recording layers is described with reference to FIG. 13.

The structure of the conventional single-layer magnetic storage medium 1300 shown in FIG. 13 is composed of, from the bottom, a silicon substrate 1301, a seed layer 1302, a magnetic layer 103-2, an isolation layer 102 and a magnetic layer 103-1 in this order and has two recording layers.

The magnetic layer 1303 has a structure similar to the first magnetic layer 103 of the present embodiment. The magnetic layer 1303-1 is a (Pt 6 Å/Co 7.1 Å)₁₀ multilayer structure, and the magnetic layer 1303-2 is a (Pt 6 Å/Co 7.8 Å)₁₀ multiplayer structure.

Each of the isolation layer 1024 and the seed layer 1302 is a Ta layer having a thickness of 5 nm.

A result of measurement of the ferromagnetic resonance absorption of the conventional single-layer magnetic storage medium 1300 is illustrated in FIG. 14.

FIG. 14 illustrates spectrum of ferromagnetic resonance absorption of the magnetic storage medium 1300 shown in FIG. 13 to which external magnetic field of 200 Oe is applied. As FIG. 14 illustrates, the ferromagnetic resonance frequency is 20 GHz or more.

The linewidth of a peak 1401 of ferromagnetic resonance absorption of the magnetic layer 1303-1 and the linewidth of a peak 1402 of the magnetic layer 1303-2 are approximately 2 GHz, respectively. To select the recording layer of the magnetic 103-1 and magnetic layer 103-2 and reproduce the data therefrom, an interval of at least 5 GHz is necessary between the peak 1401 and peak 1402. Thus, a read head is required to generate a high-frequency magnetic field in the range of 21 to 26 GHz is required, which is not practical.

According to the magnetic storage medium of the present embodiment described above, magnetic coupling is achieved between magnetization of a first magnetic layer having large perpendicular magnetic anisotropy and magnetization of a second magnetic layer having small perpendicular magnetic anisotropy and a direction of the magnetization of the second magnetic layer can be read with a low ferromagnetic resonance frequency, and consequently, data recorded in the first magnetic layer which is magnetically coupled with the second magnetic layer can be read. That is, data recorded in multiple layers can be read selectively with a low ferromagnetic resonance frequency, and thus, frequency of a high-frequency magnetic field generated by the read head can be reduced. Because such a high-frequency magnetic field as tens of gigahertz is difficult to achieve, reducing the frequency of the high-frequency magnetic field used for reproduction facilitates the readout procedure from a three-dimensional magnetic storage medium.

Moreover, since data is recorded in the first magnetic layer having large effective perpendicular magnetic anisotropy, efficient thermal stability can be guaranteed. Low ferromagnetic resonance frequency in the second magnetic layer is also desirable for the narrow linewidth of the spectrum of ferromagnetic resonance absorption thereof. Thus, intervals between peaks of the ferromagnetic resonance absorption can be secured to avoid an error in a data reproduction process and more recording layers can be provided in the medium, allowing recording density of the medium to increase.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic storage medium, comprising:
a plurality of recording layers each including at least one first magnetic layer and at least one second magnetic layer, the first magnetic layer being made of a first magnetic material which has a first effective perpendicular magnetic anisotropy, data being stored in the first magnetic layer in accordance with a direction of magnetization, the second magnetic layer being made of a second magnetic material having a second effective perpendicular magnetic anisotropy smaller than the first effective perpendicular magnetic anisotropy, first magnetization and second magnetization being in magnetic coupling, the first magnetization being magnetization of the first magnetic layer, the second magnetization being magnetization of the second magnetic layer; and
a first non-magnetic layer made of a non-magnetic material and provided between the recording layers.

2. The medium according to claim 1, wherein the first magnetization and the second magnetization are in ferromagnetic coupling.

3. The medium according to claim 1, wherein the first magnetization and the second magnetization are in antiferromagnetic coupling, the antiferromagnetic coupling indicating that directions of magnetization are opposite to each other.

4. The medium according to claim 1, further comprising a second non-magnetic layer made of a non-magnetic material and provided between the first magnetic layer and the second magnetic layer, wherein
the first magnetization and the second magnetization are coupled with each other by magnetostatic effect and magnetic exchange coupling via the second non-magnetic layer.

5. The medium according to claim 1, wherein the first magnetization and the second magnetization are coupled with each other by magnetostatic effect and magnetic exchange coupling caused by direct coupling of the first magnetic layer and the second magnetic layer.

6. The medium according to claim 1, wherein the first magnetic layer and the second magnetic layer are stacked alternately.

7. The medium according to claim 1, wherein the recording layer includes two of the first magnetic layers and one second magnetic layer is interleaved between the two of the first magnetic layers.

8. The medium according to claim 1, wherein coercivity of the second magnetic layer is smaller than the coupling magnetic field between the first magnetic layer and the second magnetic layer.

9. The medium according to claim 1, wherein the first magnetic layer has effective perpendicular magnetic anisotropy of 2 Merg/cm3 or more, and the second magnetic layer has a ferromagnetic resonance frequency of 10 GHz or less.

10. A magnetic recording apparatus, comprising: the magnetic storage medium of claim 1; and a read head.
